(19) United States
(12) Patent Application Publication
(10) Pub. No.: US 2011/0303234 A1
(43) Pub. Date: Dec. 15, 2011

(54) Hair Prosthesis

(75) Inventors: Meng Xiangyong, Shan Xian (CN); Wang Anquan, Wendeng City (CN)

(73) Assignee: WEI HAI FOLLEA ART COMPANY, Weihai (CN)

(21) Appl. No.: 12/797,988

(22) Filed: Jun. 10, 2010

(51) Int. Cl. A41G 5/00; B05D 1/38

(52) U.S. Cl. 132/54; 427/206

(57) ABSTRACT

Methods and processes for coating a hair prosthesis are provided. A method includes the steps of: providing a lace cap, the lace cap having an inner surface, an outer surface, and a plurality of openings, the plurality of openings extending from the inner surface to the outer surface, coating the inner surface of the lace cap with a first compound, attaching a plurality of hairs to the lace cap, and coating the inner surface of the lace cap with a second compound.

### FIELD OF THE DISCLOSURE

The present disclosure relates to methods and processes for creating hair prostheses. More particularly, the present disclosure relates to processes and methods for coating the inner surface of a hair prosthetic.

### BACKGROUND OF THE DISCLOSURE

Hair prosthetics may be provided, for example, to replace lost hair or to augment existing hair.

In many embodiments, hair prosthetics may include a base and a number of strands of hair that are affixed or attached to the base. The base may be porous to allow air to circulate underneath. The strands of hair may be affixed, for example, by tying the strands of hair to the base. Tying the strands of hair to the base may create an irregular or rough surface on the inner surface of the base, which may be in contact with a wearer's scalp or other skin. The rough inner surface may cause irritation to the wearer's skin, or may cause some other discomfort.

Coating the inner surface with a nonporous coating may make the inner surface of the base smoother than the base without the coating, but air may not be able to circulate through the inner surface to and from the wearer's skin, which may also create irritation or discomfort.

For at least these reasons, products and methods which create a smoother or softer inner surface for a base, yet allow for airflow and circulation through the base to and from the wearer's skin, may be important for improving overall comfort.

### SUMMARY

The present disclosure provides methods and processes for coating the inner surface of a lace cap for a hair prosthesis. The inner surface of the lace cap is coated with a first compound, and one or more strands of hair are attached to the lace cap. The inner surface of the lace cap is then coated with a second compound. The coated inner surface of the lace cap may be softer or smoother than an uncoated lace cap, which may decrease a wearer's discomfort with the hair prosthesis.

According to an embodiment of the present disclosure, a method for coating a hair prosthesis is provided. The method includes the steps of: providing a lace cap, the lace cap having an inner surface, an outer surface, and a plurality of openings, the plurality of openings extending from the inner surface to the outer surface, coating the inner surface of the lace cap with a first compound, attaching a plurality of hairs to the lace cap, and coating the inner surface of the lace cap with a second compound.

According to another embodiment of the present disclosure, a hair prosthesis prepared by a process is provided. The process includes the steps of: providing a lace cap, the lace cap having an inner surface, an outer surface, and a plurality of openings, the plurality of openings extending from the inner surface to the outer surface; coating the inner surface of the lace cap with a first compound; attaching a plurality of hairs to the lace cap, and coating the inner surface of the lace cap with a second compound.

According to yet another embodiment of the present disclosure, another method for coating a hair prosthesis is provided. The method includes the steps of: providing a lace cap, the lace cap having an inner surface, an outer surface, and a plurality of openings, the plurality of openings extending from the inner surface to the outer surface, coating the inner surface of the lace cap with a first application of a silicone rubber compound, so that substantially all of the plurality of openings remain uncovered, ventilating the lace cap with a plurality of strands of hair, the plurality of strands of hair extending from the outer surface of the lace cap to the inner surface of the lace cap and returning to the outer surface of the lace cap, and tying each of the plurality of strands of hair in a knot on the outer surface of the lace cap, and coating the inner surface of the lace cap with a second application of the silicone rubber compound, so that substantially all of the plurality of openings remain uncovered.

Additional features and advantages of the present disclosure will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a front view of a portion of the outer surface of a lace cap of the present disclosure;

FIG. 2 is a front view of a portion of the outer surface of a lace cap of the present disclosure, showing the position of a number of knots of hair;

FIG. 3 is a front view of another type of lace cap of the present disclosure, showing the position of a number of knots of hair;

FIG. 4A is a side perspective view of an exemplary knot of hair;

FIG. 4B is a cross-sectional view of the lace cap and an exemplary knot of hair along line A′ of FIG. 3 of the present disclosure; and

FIG. 5 is a flow chart of an exemplary method of the present disclosure.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION OF THE DRAWINGS

The embodiments of the disclosure described herein are not intended to be exhaustive or to limit the disclosure to the precise forms disclosed. Rather, the embodiments selected for description have been chosen to enable one skilled in the art to practice the subject matter of the disclosure. Although the disclosure describes specific methods and processes for coating a hair prosthesis, it should be understood that the concepts presented herein may be used in other various configurations consistent with this disclosure.

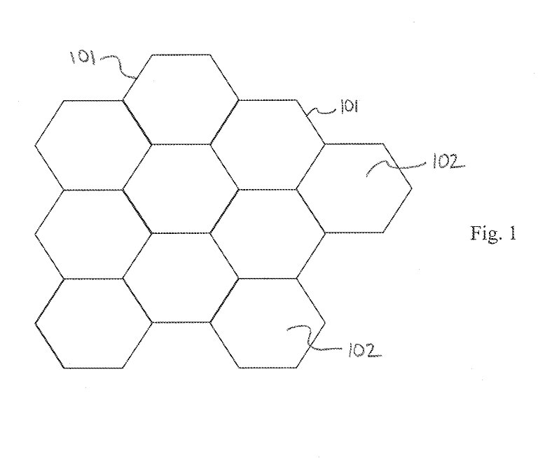

In FIG. 1, a front view of the outer surface of a lace cap 101 of the present disclosure is shown. The portion of the lace cap 101 shown in FIG. 1 is exemplary only, and the lace cap 101 may be of any size or shape. The lace cap 101 may be formed from any material. For example, and without limitation, the lace cap 101 may be formed from nylon. The lace cap 101 may be flexible, to allow the lace cap 101 to form to a wearer's scalp. The lace cap 101 may include an inner surface and an outer surface. In operation, the inner surface of the lace cap 101 may face the wearer's scalp, and may rest against the wearer's scalp. The outer surface may face away from the wearer's scalp. The lace cap 101 may be formed so that one or more openings (collectively 102) are formed, and the openings 102 may extend from the inner surface of the lace cap 101 to the outer surface of the lace cap 101. The lace cap 101 may form an attachment point for a plurality of hairs.

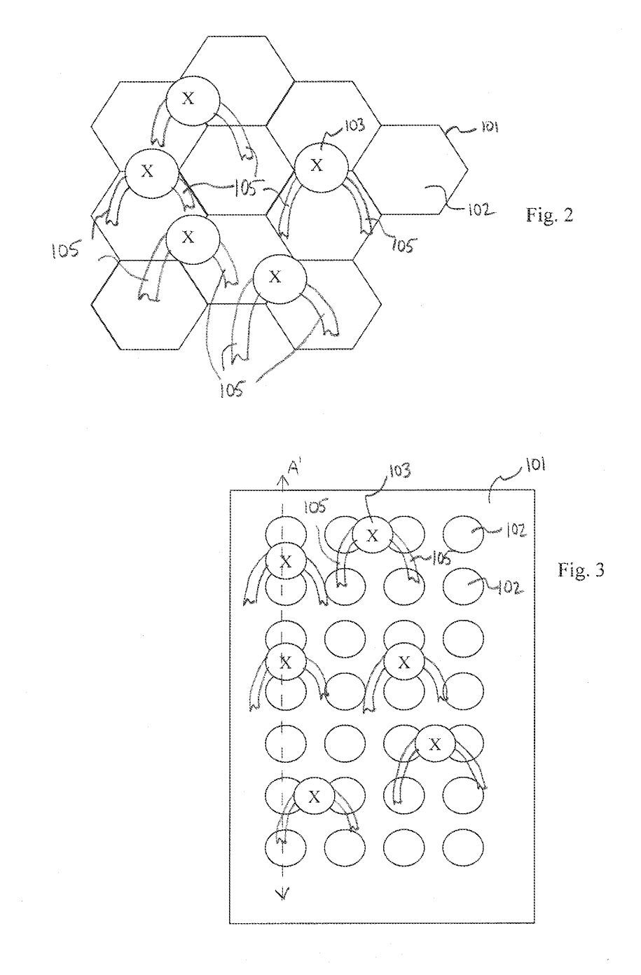

Turning now to FIG. 2, a front view of a portion of the outer surface of a lace cap 101 of the present disclosure is provided, showing the position of a number of knots of hair. In FIG. 2, a number of strands of hair 105 are shown attached to the lace cap 101. The amount and placement of the strands of hair 105 is exemplary, and more or fewer strands of hair 105 may be attached to the lace cap 101, and the knots 103 may be positioned on the lace cap 101 randomly or in any pattern desired. One or more strands of hair 105 may extend from the outer surface of the lace cap 101 to the inner surface through one of the openings 102 in the lace cap 101. The one or more strands of hair 105 may extend back to the outer surface through another opening 102 in the lace cap 101, so that a portion of the one or more strands of hair 105 rests on the inner surface of the lace cap 101. The one or more strands of hair 105 may be tied in a knot 103, so that the knot 103 rests or is positioned against the lace cap 101, and attaches or affixes the one or more strands of hair 105 to the lace cap 101. The knot 103 may be any style or number of knots 103 for attaching or affixing a strand of hair 105 to a surface. For example, and without limitation, the knot may be a “half double,” or a “double” type of knot. Additionally, one or more hairs may be tied together with the knot. Different types of knots, and differing numbers of strands of hair, may be placed on the lace cap 101 to achieve desired patterns or effects. The knot 103 may be formed at a position between the ends of the strand of hair 105, so that for each strand of hair 105 in the knot 103, two strands of hair exit the knot 103. The two strands of hair that exit the knot 103 may be of substantially equal length, or may be of differing lengths. The knot 103 may also be formed at substantially the end of the strand of hair 105, so that one strand of hair 105 exits the knot 103. In one embodiment, the knot 103 may be a loop of the strand of hair 105, that the strand of hair 105 extends through.

The strands of hair 105 may, for example and without limitation, be hair from one or more humans, hair from one or more other animals, or hair manufactured from one or more synthetic materials. The strands of hair 105 may also be mixed, so that a lace cap 101 may be affixed with a combination of human hairs, animal hairs, and/or synthetic hairs, in any percentage or frequency. A mixture of different hair types may be affixed to the lace cap 101 in a substantially random pattern, or different hair types may be affixed to the lace cap 101 in any pattern or distribution as desired. The strands of hair 105 may be of any length, thickness, and cross section, and may be a mixture of strands of hair of differing lengths, thicknesses, and/or cross sections.

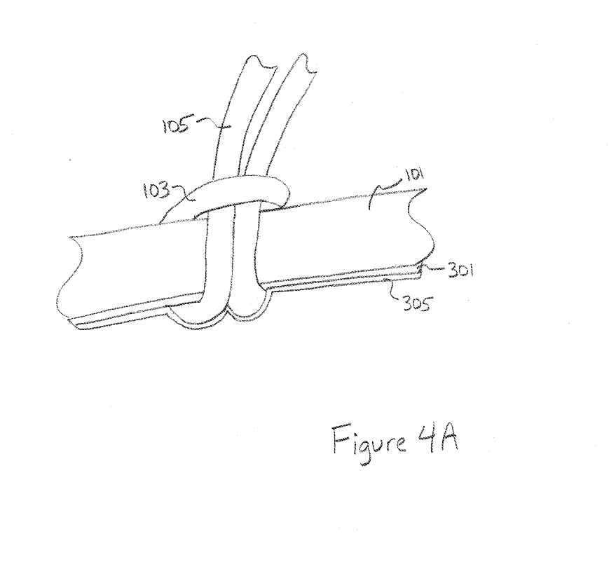

Turning now to FIG. 3, a front view of another type of lace cap 101 of the present disclosure is provided, showing the position of a number of knots 103 of hair. FIG. 3 shows an alternate style of lace cap 101, where the openings 102 in the lace cap 101 are spaced farther apart and the openings 102 are also in a repeating pattern. The knots 103 may be positioned similarly to the knots 103 on the lace cap 101 in FIG. 2, or the knots 103 may be positioned in a different pattern or style.

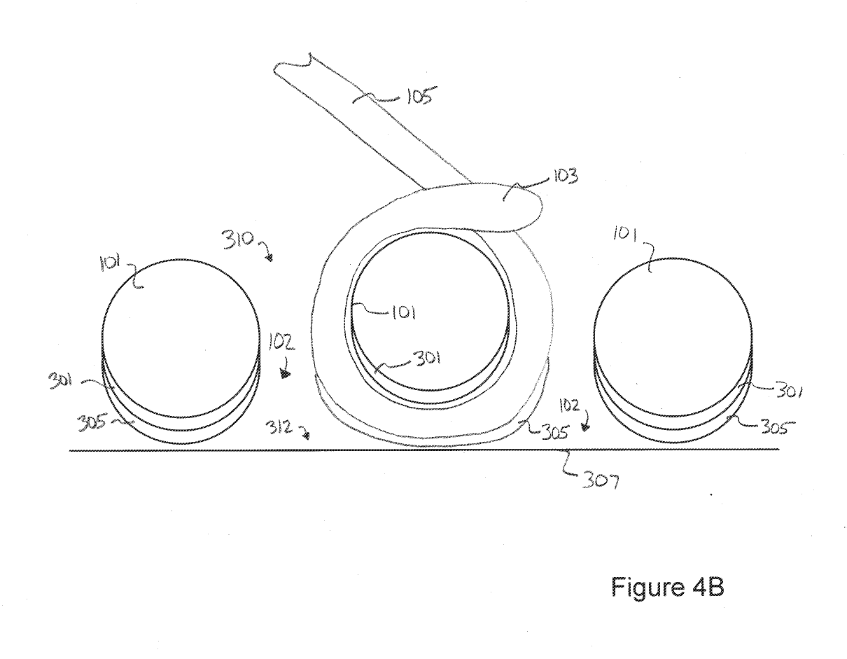

Turning now to FIGS. 4A and 4B, FIG. 4A illustrates a side perspective view of an exemplary knot of hair, and FIG. 4B illustrates a cross-sectional view of the lace cap 101 and an exemplary knot 103 of hair along line A′ of FIG. 3 of the present disclosure. A cross section of the lace cap 101 is shown, indicating openings 102 in the lace cap 101. A first compound 301 may coat the inner surface 312 of the lace cap 101. An exemplary strand of hair 105 extends from the outer surface 310 through an opening 102 in the lace cap 101 and into the inner surface 312. The strand of hair 105 then extends from the inner surface 312 to the outer surface 310 through a different opening 102, and is affixed to the lace cap 101 with a knot 103. The strand of hair 105 may exit the knot 103 and may extend out of the lace cap 101. A second compound 305 may coat the portion of the knot 103 or the strand of hair 105 that extends along the inner surface 312, or may coat the coating of the first compound 301 if a knot 103 or strand of hair 105 does not cover the first compound 301 coating.

The first compound 301 may be a soft and/or flexible material that may also have properties that allow the first compound 301 to adhere to the lace cap 101. The first compound 301 may be an elastomeric compound. For example, the first compound 301 may be silicone rubber, or a mixture of silicone rubber and one or more other compounds. The silicone rubber may include, for example, additives to change the color of the compound, or the silicone rubber may be substantially optically clear. The first compound may also include one or more thinners. For example, and without limitation, if a silicone rubber compound were used, methylbenzene may be used to thin the silicone rubber compound. Methylbenzene and silicone may be mixed at a ratio of five parts of silicone rubber to one part of methylbenzene. Other ratios may also be used to adjust the viscosity of the silicone rubber. While exemplary FIG. 4 shows that the first compound 301 is confined to the inner surface 312 of the lace cap 101, the first compound 301 may extend into the opening 102 between the inner surface 312 and the outer surface 310, and may also extend to the outer surface 310, and may coat the outer surface 310 of the lace cap 101. The first compound 301 may also substantially or completely block one or more openings 102 in the lace cap 101.

The second compound 305 may be substantially similar or identical to the first compound 301, or the second compound 305 may be different than the first compound 301. The second compound 305 may be a soft and/or flexible material that may also have properties that allow the second compound 305 to adhere to the lace cap 101, the first compound 301, the knot 103, and/or to the strands of hair 105. The second compound 305 may be an elastomeric compound. For example, the second compound 305 may be silicone rubber, or a mixture of silicone rubber and one or more other compounds. While exemplary FIG. 4 shows that the second compound 305 is confined to the inner surface 312 of the lace cap 101, and substantially covers the first compound 301 on the inner surface 312 where a strand of hair 105 does not cover the first compound 301, the second compound 305 may extend into the opening 102 between the inner surface 312 and the outer surface 310, and may also extend to the outer surface 310, and may coat the outer surface 310 of the lace cap 101. The second compound 305 may also substantially or completely block one or more openings 102 in the lace cap 101.

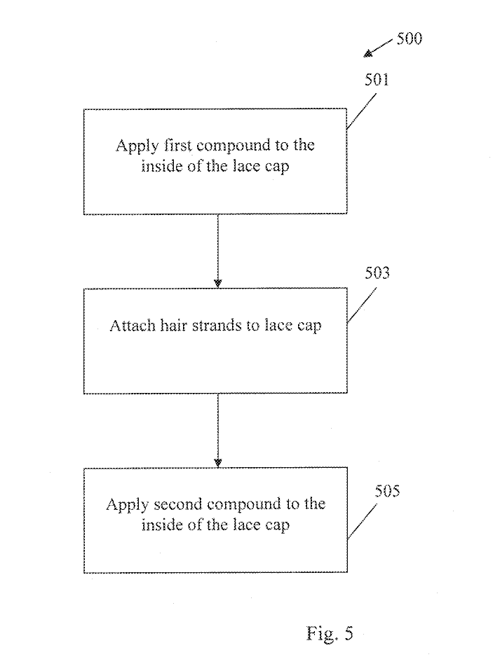

Turning now to FIG. 5, a flow chart of an exemplary method 500 of the present disclosure is shown.

In step 501, the first compound 301 is applied to the inner surface 312 of the lace cap 101. The first compound 301 may be applied using any method of applying a compound to a surface. For example, the first compound 301 may be spread, or rolled, or brushed onto the inner surface 312 of the lace cap 101, or the first compound 301 may be sprayed onto the inner surface 312 of the lace cap 101. For example, and without limitation, the first compound may be applied to the inner surface 312 of the lace cap 101 by hand, and may be patted onto the lace cap 101.

The application of the first compound 301 to the lace cap 101 may not cover or close some or all of the openings 102 in the lace cap 101, so that some or all of the openings 102 in the lace cap 101 may remain open or uncovered. For example, and without limitation, the application of the first compound 301 to the inner surface 312 of the lace cap 101 may allow 50% or more of the openings 102 in the lace cap 101 to remain open. The application of the first compound 301 to the inner surface 312 may also allow substantially all or all of the openings 102 in the lace cap 101 to remain open. In one embodiment, the first compound may be allowed to dry after the application to the lace cap 101. In one embodiment, the first compound is allowed to dry for approximately two hours, although drying time may be either more or less than two hours. For example, drying time may depend on the temperature and/or the humidity of the air surrounding the lace cap 101 as it is drying.

In step 503, strands of hair 105 are tied or ventilated to the lace cap 101. The strands of hair 105 may be positioned so that one or more strands of hair 105 extends from the outer surface 310 of the lace cap 101, through one of the openings 102 in the lace cap 101 to the inner surface 312, and continues from the inner surface 312 to the outer surface 310 through a different opening 102. The strands of hair 105 may be tied in a knot 103 so that the strands of hair 105 wrap around a portion of the lace cap 101. The knot 103 may be formed from the strands of hair 105 on the outer surface 310 of the lace cap 101.

In step 505, the second compound 305 is applied to the inner surface 312 of the lace cap 101. The second compound 305 may be applied using any method of applying a compound to a surface, and the second compound 305 may be applied to the inner surface 312 of the lace cap 101 in a similar manner as the first compound 301 was applied. For example, the second compound 305 may be spread or rolled onto the inner surface 312 of the lace cap 101, or the second compound 305 may be sprayed onto the inner surface 312 of the lace cap 101.

The application of the second compound 305 to the lace cap 101 may not cover or close some or all of the openings 102 in the lace cap 101, so that some or all of the openings 102 in the lace cap 101 may remain open or uncovered. For example, and without limitation, the application of the second compound 305 to the inner surface 312 of the lace cap 101 may allow 50% or more of the openings 102 in the lace cap 101 to remain open. The application of the second compound 305 to the inner surface 312 may also allow substantially all or all of the openings 102 in the lace cap 101 to remain open. The application of the second compound 305 may also substantially cover or cover the first compound 301 on the inner surface 312 of the lace cap 101.

The second compound 305 may coat or substantially coat the portion of the strands of hair 105 that are on the inside surface of the lace cap 101. The second compound 305 may operate with the knot 103 on the outer surface 310 of the lace cap 101 to hold the strands of hair 105 in place, and prevent the knot 103 from loosening or moving.

The first compound 301 and the second compound 305 may be applied so that the first compound 301 and/or the second compound 305 may be in contact with the wearer's skin 307 when the wearer wears the hair prosthetic. The first compound 301 and the second compound 305 may be applied so that contact between the inner surface 312 of the lace cap 101, including the strands of hair 105 on the inner surface 312 of the lace cap 101, and the wearer's skin 307, is substantially reduced. The first compound 301 and the second compound 305 may be softer or smoother against the wearer's skin 307 than the lace cap 101 and the strands of hair, and may feel like rubber to the touch, which may reduce the wearer's discomfort. Also, a number of openings 102 in the lace cap 101 may remain open, allowing airflow and circulation through the inner surface 312 of the lace cap 101 to the wearer's skin 307, which may also reduce the wearer's discomfort.

While this disclosure has been described as having exemplary designs, the present disclosure can be further modified within the spirit and scope of this disclosure. This application is therefore intended to cover any variations, uses or adaptations of the disclosure using its general principles. Further, this application is intended to cover such departures from the present disclosure as come within known or customary practice in the art to which this disclosure pertains and which fall within the limits of the appended claims.

What is claimed is:

1. A method for coating a hair prosthesis, the method comprising:
providing a lace cap, the lace cap having an inner surface, an outer surface, and a plurality of openings, the plurality of openings extending from the inner surface to the outer surface;
coating the inner surface of the lace cap with a first compound;
attaching a plurality of hairs to the lace cap; and
coating the inner surface of the lace cap with a second compound.

2. The method of claim 1, wherein coating the inner surface of the lace cap with the first compound does not close at least 50% of the plurality of openings in the lace cap.

3. The method of claim 1, wherein coating the inner surface of the lace cap with the second compound does not close at least 50% of the plurality of openings in the lace cap.

4. The method of claim 1, wherein attaching the plurality of hairs to the lace cap includes ventilating the lace cap with a plurality of hairs, the plurality of hairs extending from the outer surface of the lace cap to the inner surface of the lace cap and returning to the outer surface of the lace cap, and tying each of the plurality of hairs in a knot, the knot positioned against the lace cap.

5. The method of claim 1, wherein the first compound is substantially similar to the second compound.

6. The method of claim 5, wherein the first compound and the second compound are a compound with elastomeric properties.

7. The method of claim 6, wherein the compound with elastomeric properties is silicone rubber.

8. The method of claim 1, wherein more than half of the plurality of hairs are hairs from a human.

9. The method of claim 1, wherein more than half of the plurality of hairs are formed from a synthetic material.

10. A hair prosthesis prepared by a process comprising the steps of:
providing a lace cap, the lace cap having an inner surface, an outer surface, and a plurality of openings, the plurality of openings extending from the inner surface to the outer surface;
coating the inner surface of the lace cap with a first compound;
attaching a plurality of hairs to the lace cap; and
coating the inner surface of the lace cap with a second compound.

11. The process of claim 10, wherein coating the inner surface of the lace cap with the first compound does not close at least 50% of the plurality of openings in the lace cap.

12. The process of claim 10, wherein coating the inner surface of the lace cap with the second compound does not close at least 50% of the plurality of openings in the lace cap.

13. The process of claim 10, wherein attaching the plurality of hairs to the lace cap includes ventilating the lace cap with a plurality of hairs, the plurality of hairs extending from the outer surface of the lace cap to the inner surface of the lace cap and returning to the outer surface of the lace cap, and tying each of the plurality of hairs in a knot, the knot positioned against the lace cap.

14. The process of claim 10, wherein the first compound is substantially similar to the second compound.

15. The process of claim 14, wherein the first compound and the second compound are a compound with elastomeric properties.

16. The process of claim 15, wherein the compound with elastomeric properties is silicone rubber.

17. The process of claim 10, wherein more than half of the plurality of hairs are hairs from a human.

18. The process of claim 10, wherein more than half of the plurality of hairs are formed from a synthetic material.

19. A method for coating a hair prosthesis, the method comprising:
providing a lace cap, the lace cap having an inner surface, an outer surface, and a plurality of openings, the plurality of openings extending from the inner surface to the outer surface;
coating the inner surface of the lace cap with a first application of a silicone rubber compound, so that substantially all of the plurality of openings remain uncovered;
ventilating the lace cap with a plurality of strands of hair, the plurality of strands of hair extending from the outer surface of the lace cap to the inner surface of the lace cap and returning to the outer surface of the lace cap, and tying each of the plurality of strands of hair in a knot on the inner surface of the lace cap; and
coating the inner surface of the lace cap with a second application of the silicone rubber compound, so that substantially all of the plurality of openings remain uncovered.
